(19) United States
(12) Patent Application Publication
(10) Pub. No.: US 2026/0072931 A1
(43) Pub. Date: Mar. 12, 2026

(54) APPLICATION OF AN AI-BASED MODEL TO A PREPROCESSED DATA SET

(71) Applicant: Formic Al Ltd., Toronto (CA)

(72) Inventors: Varun Ranganathan, Bangalore (IN); Benjamin Christie, Toronto (CA)

(21) Appl. No.: 19/107,497

(22) PCT Filed: Sep. 26, 2023
(86) PCT No.: PCT/CA2023/000030

§ 371 Date: Feb. 27, 2025

Related U.S. Application Data
(60) Provisional application No. 63/409,877, filed on Sep. 26, 2022.
(60) Provisional application No. 63/465,118, filed on May 9, 2023.

(51) Int. Cl. G06F 16/25; G06F 16/332; G06F 40/284

(52) U.S. Cl. CPC G06F 16/254; G06F 16/3328; G06F 40/284

(57) ABSTRACT

Systems and methods relating to the application of AI related models to a corpus of data. The corpus of data is initially preprocessed by way of a tokenization process. This produces tokenized data that may then be grouped into groups of tokenized data. The tokenized data is then processed, either sequentially or in parallel, by one or more AI-related models. Each of the models implements a specific language task such as prediction, sentiment analysis, summarization, and others. All data adjustments, data processing, and data generation, both during the preprocessing and the AI model implementation, are stored such that other downstream processes can take advantage of the information generated by these processes.

### TECHNICAL FIELD

The present invention relates to data processing and the implementation of AI related models to a corpus of data. More specifically, the present invention relates to systems and methods for preprocessing the corpus of data and then using the preprocessed data with suitable AI related models for specific tasks such as language tasks.

### BACKGROUND

Artificial Intelligence (AI) is a branch of computer science that deals with algorithms which seek to simulate human cognitive abilities in a machine. The core of AI-powered systems are algorithms that make predictions about certain aspects of its environment, using techniques ranging from simple rule-based procedures to complex statistics-based machine learning. AI-based algorithms are generally utilized in two scenarios:
i) where it is extremely hard to gather all information required to perform a task; and
ii) where the computational burden is too high to solve a task, even if all the informational pieces required are available.

Using AI in these situations can provide efficient solutions to complex problems.

In line with the two use-case scenarios for AI, from the 1950's to the early 2010's traditional AI methods were limited by the availability of computational resources and data. This resulted in algorithms being solved sufficiently through rule-based approaches. However, such approaches were extremely limited in scope relative to modern machine learning based approaches. Modern AI is driven by such statistics-based machine learning techniques, resulting in the analysis of large data sets in a finite duration of time. Such algorithms primarily perform actions that optimize for feedback generated by its environment. In this process of learning “an action”, machine learning models learn to mimic the data being inputted through generalized rules. Resulting from these actions, such models develop an intuition as to how the input(s) and output(s) are related. Then, unknown input(s) can be applied to the model, but only to perform a specific task. The handling of unknown input(s) allowed AI to set itself apart from traditional computer algorithms which require every scenario-action pair to be explicitly determined, either in code or in a database.

Today's approaches to AI are driven by deep learning, a subset of machine learning, specifically through large language modeling. The conceptual approach is two phased:
i) Use a large mathematical model and “pre-train” on a task that can be generally applied across a domain, such as natural language, vision, audio, or video. By learning to perform a generalized action across an informational modal, the model learns various general and specific representations. Given large amounts of data, an adequately parameterized model can learn generalized representations for the data pieces it has been trained on.
ii) After “pre-training”, the model is “fine-tuned” on a specific action and/or task. The specificity comes from either how the action is performed or the subset of data it is further trained on. The crux of this idea is to utilize the pre-trained model's generalized representations to uncover correlations within dataset pieces that are not explicit but could be inferred through an external knowledge base. This often leads to higher accuracies on development sets (i.e., the subset of the dataset used to validate the model).

Today's large language modeling techniques primarily depend on a mathematical model called “Transformers”. Almost all commercially successful and publicly popular language modeling techniques are built around the Transformer model. Often dubbed as a “foundational” model, Transformers have allowed computers to generate value from very large amounts (hundreds of gigabytes and even terabytes) of data. The value is generally found in the ability for a Transformer based system to understand and generate human language. Common examples of these systems are text-focussed systems such as GPT-3, BLOOM, GOPHER, or NLLB. Such systems have pushed the bounds of computers being able to complete many language-based tasks such as Sentiment Analysis, Summarization, Content Generation, etc. Use cases of this language-based technology can span across multiple industries or across any task that requires any sort of language analysis or generation. Common examples are machine translation, automatically written social media posts, entity extraction from complex contracts, and more. Furthermore, some organizations have begun applying Transformer based systems on image processing to allow computers to create their own image-based content (e.g., DALL-E 2).

With today's Transformer based approach to large language modeling comes with a number of disadvantages. As Transformer models do not model the temporal nature of a sequence, their primary flaws are very apparent in both commercial and academic settings. While Transformer based systems have been successful at reaching high accuracies on language-based tasks, one of their main flaws is that they require hard-coded or learnable position embeddings for each time step in the sequence, adding additional computational overhead.

Current techniques also have other issues. As an example, current machine learning techniques requires the practitioner to decide on a static computation graph, restricting the maximum number of features acceptable by the system. For example, today's commercial Transformers generally have a window of context of 2048, i.e., they can only accept and hold context within those 2048 input tokens.

Similarly, since deep learning partially involves compressing the dataset into a complex parameter space, it loses explainability. Biases that are present in data cannot be tracked back to the data pieces that induced the bias.

In addition, as pre-training corpuses consist of only “positive” examples of token sequences, “negative” examples need to be generated, implicitly or explicitly. This induces unexplainable biases, because models tend to learn spurious rules from negative examples, which are usually generated automatically on-the-fly.

Based on the above, there is therefore a need for systems and methods that mitigate, if not overcome the issues as noted above.

### SUMMARY

The present invention provides systems and methods relating to the application of AI related models to a corpus of data. The corpus of data is initially preprocessed by way of a tokenization process. This produces tokenized data that may then be grouped into groups of tokenized data. The tokenized data is then processed, either sequentially or in parallel, by one or more AI-related models. Each of the models implements a specific language task such as prediction, sentiment analysis, summarization, and others. All data adjustments, data processing, and data generation, both during the preprocessing and the AI model implementation, are stored such that other downstream processes can take advantage of the information generated by these processes.

In a first aspect, the present invention provides a method for processing a corpus of data using at least one AI-based model, the method comprising:
a) receiving said corpus of data;
b) applying a pre-processing method to said corpus of data to generate and extract information regarding said data in said corpus of data and to generate preprocessed data, said preprocessed data being stored in a graph database;
c) applying said at least one AI-based model to said preprocessed data using an execution block.

In another aspect, the present invention relates to a system for implementing a language task using an AI related model, the system comprising:
a tokenizer for receiving and tokenizing a corpus of data to result in tokenized input data;
a language task solver module receiving said tokenized input data and applying said AI related model to said tokenized input data; wherein
said tokenizer tokenizes at least a portion of said corpus of data by recursively decomposing said portion into smaller and smaller sub-groups of data, wherein for each sub-group of data that said portion is decomposed into, said sub-group is tokenized and a resulting token is stored in a node in a tree along with multiple parameters relating to said resulting token;
said language task solver is implemented in an execution block.

### BRIEF DESCRIPTION OF THE DRAWINGS

The embodiments of the present invention will now be described by reference to the following figures, in which identical reference numerals in different figures indicate identical elements and in which:

FIG. 1 is a flowchart detailing steps in method according to one aspect of the present invention;

FIG. 2 is a flowchart detailing the steps in a sub-method for tokenizing or preprocessing a corpus of data according to one aspect of the present invention;

FIG. 3 is a block diagram illustrating data flow and components involved in solving/implementing a language task according to another aspect of the present invention;

FIG. 4 is a block diagram schematically illustrating data flow for a process that involves a language task and classifying outputs;

FIG. 5 is a schematic block diagram of a 2-0 Block used in the process illustrated in FIG. 4;

FIG. 6 is a schematic block diagram of an M-1 Solver and Classifier as used in the process illustrated and detailed in FIG. 4;

FIG. 7 is a schematic block diagram illustrating data flow for a process for a prediction based language task;

FIGS. 8A and 8B are schematic block diagrams illustrating data flow for a process involving a summarizing based language task.

### DETAILED DESCRIPTION

In one aspect, the present invention provides a system and a method for applying one or more AI based models on a corpus of data. The AI based models, in one embodiment, executes a language-based task. The corpus of data is first preprocessed to gather information about the interrelationships between the various data points in the corpus. The resulting preprocessed data is then processed using an execution block to produce the desired output. The execution block may involve one or more execution units that process the preprocessed data sequentially or in parallel and may involve extra processing steps (such as labeling or sorting) in addition to the application of the AI based model to the preprocessed data.

In one embodiment of the present invention, there is provided a dynamic programming environment for AI agents using a data model and a graph database to perform language tasks in artificial intelligence processes. The various embodiments of the present invention provide for deterministic and stochastic ways to incorporate external knowledge for AI task solving while ensuring that both are controllable.

For clarity, dynamic programming refers to the act of simplifying a complicated problem by breaking it down into simpler sub-problems in a recursive manner.

The process of “solving” a task requires “understanding”. To tackle a hard problem such as “language understanding”, the present invention allows AI agents to employ dynamic programming methods by, i) providing a working memory in the form of a tape (or any suitable computer storage or memory in which data transformations and data transactions are stored), and ii) providing deterministic and stochastic representations of the input, iii) providing methods to cache results back onto the working memory.

For even greater clarity, the term “environment” is to be taken to refer to the process within which the AI agent needs to perform actions. The environment of the present invention provides AI agents with an “unlimited” memory, pre-filled with external “prior” information about the input data. In one variant, this environment provides AI agents with a “limited” memory, with or without any prior information about the input data.

In one aspect, the present invention allows for multiple documents of variable unlimited lengths to be taken and for the performance of any specific “language task” upon the input document(s) to return one variable unlimited-length document containing required results.

Within the context of the present invention, the term “AI agent” is to be taken to refer to any AI-based algorithm or software that has been developed to perform a specific task. This can be any program that behaves intelligently given the scenario. It should be clear that this definition encompasses a wide range of processes, ranging from those that are rules-based to those that are statistical. That being said, it should be clear that the AI algorithm (or the AI based model) noted in this document in the context of the present invention was developed to perform one specific task in its environment.

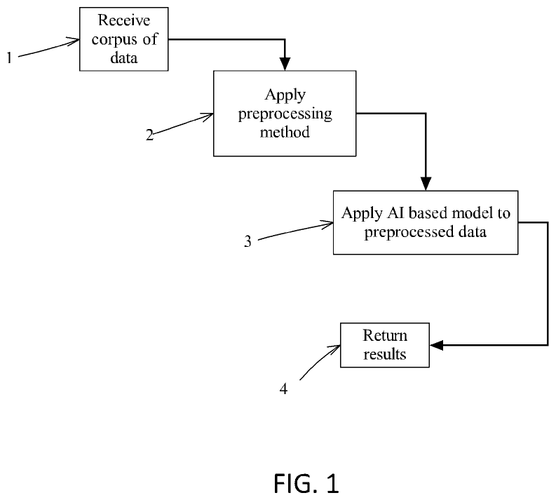

The process of the present invention can be encapsulated in the flowchart of FIG. 1. As can be seen, the process begins at step 1, that of receiving the corpus of data. As noted above, this corpus of data may be a collection of documents to which an AI-based model is to be applied. Step 2 is that of applying a preprocessing method to the corpus of data. This preprocessing method produces preprocessed data and also produces information about the data in the corpus, such as interrelations between data points, how data points affect one another, etc., etc. The preprocessed data is then used with the AI based model (step 3) that may be related to a language task. The result of step 3 includes the returned values of the overall process.

### Preprocessing by Tokenization

In one embodiment, the preprocessing method tokenizes the corpus of data (or the input data) and produces a tree of tokens. The tree can then be incorporated into a graph database or can be the graph database itself. This process is detailed below and in the PCT application PCT/CA2023/051183 which is hereby incorporated by reference in its entirety.

The process by which input data is preprocessed to produce tokenized data is detailed below. For this process of encoding and storing a corpus of data, a collection or subset of the corpus of data is recursively decomposed and tokenized and the resulting tokens are stored in a tree data structure. The tree data structure can be implemented as a database of graphs. Parameters are generated for each resulting token and are stored with the relevant token. Once the subset of the corpus of data has been decomposed and the resulting tokens (and their parameters) are stored, the resulting tree is then added to a larger tree. For some implementations, this may involve adding the various tokens (stored as a graph) and their parameters to a relevant database. For other implementations, the various tokens (stored as a graph) and their parameters are used to create the graph database.

Regarding each token's parameters, these parameters may be adjusted as necessary or may even be added to, depending on the system configuration. As an example, parameters may be adjusted or more parameters may be added every time an analysis of the tree is executed.

It should be clear that the decomposition of each collection of data is performed recursively and that each step of the decomposition generates one or more tokens. It should also be clear that a large corpus of data (which may include documents, images, video, or any number of types of data) can be encoded and stored by any number of execution units operating in parallel, with each execution unit processing a subset of the corpus of data. A coordinator processing unit may coordinate between the various execution units to ensure data integrity in the various sub-trees being generated prior to the sub-trees being grafted or incorporated into a larger tree.

The larger tree, once the corpus of data has been encoded and stored in multiple sub-trees and the sub-trees have been incorporated into the larger tree, can be analyzed and utilized using any number of tools to obtain useful results. As examples, the larger tree (implemented as a database of graphs) may be searched for specific content and analyzed and mined for useful conclusions. Each time the larger tree is analyzed or searched, the various parameters for the tokens may be adjusted or added to as detailed above.

In terms of searching and analysis of the larger tree, the larger tree can be quite large, especially as the tokens (stored as nodes in the tree) are generated for each step of the decomposition. To ensure that the searching and/or analysis are performed in finite and reasonable time, the larger tree may be divided into sub-trees and each sub-tree can be searched and/or analyzed by one or more execution units, with the one or more execution units operating in parallel. The results from these various execution units can then be sent to one or more corresponding coordination units that ensure that the results are consistent and suitable for the desired task.

It should also be clear that the resulting larger tree and the methods and systems of the present invention efficiently encode “extra” world knowledge, such as contextual understanding, localizations, and general knowledge. These can be encoded by way of the various parameters that may be generated for each token.

The use of a token based tree structure allows for the systems and methods of the present invention to seamlessly interoperate across distinct informational modals. In one aspect, it is preferred that at least one aspect of the present invention provides for a system that can accept unstructured natural language, images, audio, video along with structured data residing in databases.

As noted above, the search and/or analysis (as well as the generation) of the larger tree can be executed using multiple execution units operating in parallel. Preferably, the various execution units are operating in parallel independently of one another so that the benefits of true parallel execution can be taken advantage of. This allows for the systems of the present invention to be run in a computationally affordable environment. Affordability is directly related to the ability for a system to be pre-trained, fine-tuned, and inferred at a fractional efficiency in comparison to transformer-based solutions.

In another aspect, the present invention provides for a system that is not restricted by the static computational graphs, thereby allowing the user to input information of any length while having the system hold context throughout the entirety of the input.

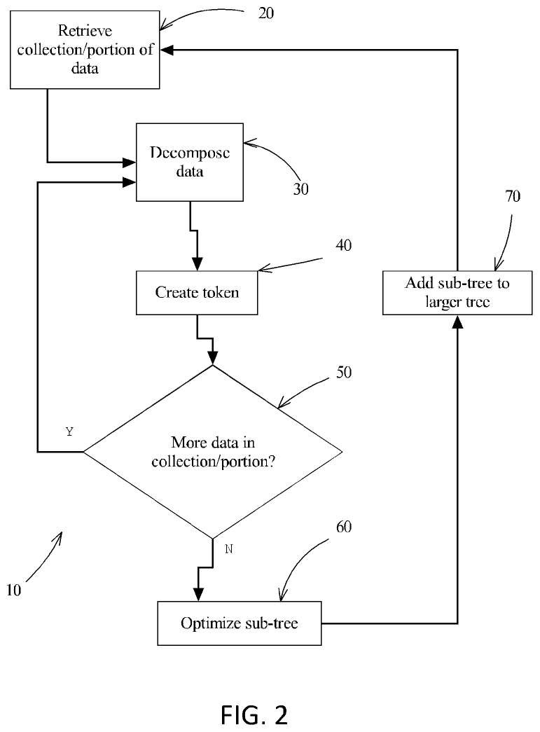

Referring to FIG. 2, a flowchart 10 of a method according to one aspect of the present invention is illustrated. As can be seen, the first step 20 of the method is that of retrieving a collection of data from a larger corpus of data. This collection of data, which may be comprised of documents, images, unstructured or structured data, or any mixture of types of data, is retrieved from the corpus of data. A portion of that collection of data is then separated from the collection and the portion is to be processed. In the event the collection of data is a mixture of various data types, the data type of the portion of data is determined and suitable parameters and configurations for the execution unit are adjusted for the specific data type being processed. In one exemplary embodiment of the present invention, the collection of data is comprised of documents and is to be used in the execution of a language based task.

Once the data type has been determined for the portion to be processed, that portion is then decomposed (step 30). Tokens from the decomposition are then created (step 40) and suitable parameters for these created tokens are determined and the tokens are stored in nodes in a sub-tree. If there is more data in the portion to be decomposed (decision 50), then the logic flow returns to step 30 as the portion of data is recursively decomposed until the portion has been decomposed into the smallest units of data for that data type. Of course, each step in the decomposition generates one or more tokens and these tokens are stored in the nodes of the sub-tree and their relevant parameters are stored as well.

After the portion of data has been decomposed into the smallest units of data for that data type, another portion of the collection of data can be retrieved and steps 30-50 can be repeated for each portion of data until the collection of data from the corpus has been encoded and stored in a resulting sub-tree. Once the collection of data has been encoded into a sub-tree, one optional step is to optimize the resulting sub-tree generated (step 60). Optimizing the sub-tree is optional but may assist in the efficient processing of the sub-tree when the nodes in the sub-tree and their parameters are being searched and/or analyzed. This optional optimization step is explained in more detail below.

In the event that the optional optimization step is skipped or after the optimization step has been executed, the resulting sub-tree is then grafted on to the larger tree. In practical terms this means that the data generated for the sub-tree is merged into the larger database (step 70). Of course, after the sub-tree has been merged into the larger tree, the execution unit executing the method can repeat the method with a new collection of data from the corpus of data. Alternatively, instead of grafting the resulting sub-tree into a larger tree, the resulting sub-tree may be used as the basis for a larger tree and other sub-trees may be grafted on to the current sub-tree.

Regarding the decomposition of the portion of data, as noted above, each step in the decomposition generates one or more tokens. As well, as noted above, the decomposition continues until the portion is decomposed into the smallest unit of data for that data type. As an example, if the portion of data to be decomposed is text data, then the smallest unit of data is that of a letter. If the original portion is a sentence, then the sentence generates a token and the decomposition generates multiple tokes as each word and phrase in the sentence is decomposed. As an example, if the sentence to be decomposed is “This is a sentence” then this sentence generates one token for the original sentence. The sentence also generates tokens for the following words and phrases and these are detailed in the following decomposition steps:

step 1 (Decompose by removing the left most word and create two tokens-—one for the removed word and one for the remaining words)

TOKEN: This

TOKEN: is a sentence

step 2 (continue and repeat from the remaining words)

TOKEN: is

TOKEN: a sentence

step 3 (continue and repeat from the remaining words)

TOKEN: a

TOKEN: sentence

step 4 (Decompose by removing the right most word and create two tokens-—one for the removed word and one for the remaining words)

TOKEN: sentence

TOKEN: This is a

step 5 (continue and repeat from the remaining words)

TOKEN: a

TOKEN: This is

step 6 (continue and repeat from the remaining words)

TOKEN: is

TOKEN: This

step 7 (Decompose each word and generate one token per letter from the word) (tokens omitted)

As can be seen, the successive removal of one word per step from the sentence may generate multiple tokens per step. Steps 1-3 removes a left most word from the sentence/phrase and the process continues until no words are left. Steps 4-6 removes a rightmost word from the sentence/phrase and the process continues until no words are left. Step 7 decomposes each word in the sentence into its constituent letters. Each letter generates a token.

From the above, it can be seen that some tokens may seem to be duplicates of others. However, since each token is generated at a different time step (i.e. each token's parent tokens tend to be different even if the token is the same), these tokens are different. As an example, the token “a” in step 5 is different from the token “a” in step 3 as each are generated from different phrases (i.e. the parentage is different). Similarly, the token for the letter “i” from the word “is” is a different token from the token for the letter “i” from the word “is”. However, the 3 tokens for the letter “e” from the word “sentence” may be, depending on the implementation, considered to be redundant and may be removed in an optimizing step.

For clarity, parameters for the various tokens may indicate the parentage and/or genealogy and/or ancestry of a token. As an example, the token for “is” may have parameters detailing that it has two child tokens (for the letters “i” and “s”) and may include parameters detailing that the token derives from the token for the phrase “This is” and from the token for the original sentence “This is a sentence”. Such parameters allow for execution units to trace a token's sources as well as a token's offspring. Of course, if the implementation only allows for a one-way directed graph implementation, then the parameters may only indicate a token's offspring (i.e. which tokens derive from the current token). Similarly, a token's parameters may not simply identify that token's offspring but how many tokens derive from that original token.

It should also be clear that each original collection of data generates its own first token prior to being decomposed and that the corpus of data generates its own original token. For a corpus of data that is comprised of text data, each subset of that corpus (whether that subset is a section, a chapter, a paragraph, a sentence, a phrase, etc., etc.) can generate its own subtree and that the union of all those subtrees results in the large tree that encodes the whole corpus. For other types of data, such as digital images, digital audio files, digital video files, other subsets may, of course, be used. As an example, for digital images, the subset may be a digital image and that subset can be decomposed into sections of that digital image. For such a data type, the smallest unit of data may be a pixel and the parameters for the various subsets (e.g. for a section of the digital image) may include image characteristics of the subset such as huc, brightness, color, palette used, etc., etc.

As can be imagined, given that each token can have many parameters (some detailing genealogy, some being identifying indices, while other parameters may detail other characteristics of the token), each token may have many parameters. For some implementations, tokens may have dozens if not hundreds of parameters and these parameters may be added to or may be adjusted by processes that analyze and/or search through the tokens.

From the above, it was noted that an optional step may be the optimization of a sub-tree prior to its inclusion into the larger tree. Optimization may take the form of removing or minimizing duplicate tokens. As an example, the 3 tokens for the letter “c” from the word “sentence” in the example above may be optimized so that only one token is used in the sub-tree. The other two tokens for the same letter (and which should have identical parameters) may be removed for optimization purposes.

Optimization may also take the form of applying forward propagation and/or backpropagation processes to the sub-tree. Such processes would adjust at least some of the parameters of the various tokens and may even add parameters to the tokens. As well, backpropagation through time may also be applied to the sub-tree. Backpropagation through time is a well-known technique used in AI applications.

It should be clear that other optimization methods and processes may be applied to the sub-tree to ensure that the sub-tree nodes are optimized in terms of number of nodes, organization of nodes, and to ensure that the sub-tree is easier to traverse/use.

Once the sub-tree has been optimized, it can then be incorporated into the larger tree. As noted above, one alternative is to use the sub-tree, whether optimized or not, as the basis for a new larger tree.

After the sub-tree has been created, it can be incorporated into a graph database as noted above.

### Incorporating Into the Graph Database

In the event the corpus of data takes the form of different forms or formats, these can also be incorporated into the graph database as noted below.

In one implementation, the graph database uses two databases-—a bidirectional key-value mapping database (i.e., a database that can search over both keys and values), and another database that will hold the edges for the final graph database. A node counter is also used to create a unique ID for every string that is inputted into the database system.

In the event the corpus of data, or a subsection of that corpus of data, takes the form of a knowledge graph, this knowledge graph can be incorporated into the database as explained below. For clarity, a Knowledge Graph (KG) is a labeled, directed graph G=(E, R, L) consisting of a set of entities E, which correspond to unique objects, a set of relations R, which are labels applied to links, and a set of links L⊆E×E×R. Each link connects one so-called “source entity” es ∈ E to a “target entity” et ∈ E, assigning a relation r ∈ R to that pair (es, et), resulting in a triple represented as (es, r, et). In the real world, these triples represent facts that have been extracted from published data, describing how all real-world objects interact with each other.

Incorporating or grafting a knowledge graph to the database may be accomplished by, essentially, extracting the source entity, the target entity and the relation from a fact in the knowledge graph. Additional metadata, if available, can be extracted as well and can be added to the source, target, and relation points of data. These are then added to a node in a temporary graph. All the facts in the knowledge graph are similarly processed until no more facts are left to process and the temporary graph of nodes is complete. This temporary graph can then be incorporated into the graph database.

As noted above, the corpus of data may take other forms or formats of data. In the event the corpus of data or its subset takes the form of raw data, this can also be incorporated into the graph database.

For clarity, the term “raw data” refers to data dumps. These dumps of data may be stored in any database or simply in a file system. It should be clear that even highly unstructured data is slightly structured due to the fact that it is organized within a file system. Each file within raw data contains data entries and each data entry is a type of key-value pair. In some cases, the key could be a unique feature identifier while in other cases, the key could simply be a unique value identifier.

The raw data can be incorporated into the graph database by, essentially, processing each entry in the raw data separately. Each entry is processed such that all keys and values in the entry are extracted. A node identifying the data dump and the entry is created in a temporary graph and the extracted keys and values are added to the newly created node. Each entry is processed in turn and, since each entry generates a node, the result is a temporary graph. Once all entries have been processed, the resulting temporary graph is incorporated or grafted on to the graph database.

In the event the corpus of data includes or is composed of datasets, these can also be incorporated into the graph database. For clarity, and in the context of this document, a dataset is a subset of data used for AI purposes. Datasets, for our purposes, are comprised of special data entries called data points. Each data point generally comprises of inputs and outputs. Inputs need to be processed and fed to a downstream AI process. Outputs are what the downstream AI process needs to provide for that particular set of processed inputs. It should also be clear that datasets may, depending on the circumstances, only have inputs, sometimes implicitly acting as the output. In other cases, the representation of inputs needs to be converted to another form.

To process a dataset, each data point in the dataset is processed by first extracting the inputs and the outputs from the data point being processed. A node is then created in a temporary graph and the inputs and outputs extracted from the data point are added to the node. As should be clear, the node identifies the dataset and the data point being represented by the node. Each data point is processed in turn and the resulting temporary graph with all the nodes can then be incorporated into the graph database.

For clarity, the term “graph database” can be taken to mean a database that uses graph structures for semantic queries with nodes, edges, and properties to represent and store data. Graphs contain nodes, edges, and properties, all of which are used to represent and store data in a way that relational databases are not equipped to do.

Graph databases use topographical data models to store data. These databases connect specific data points (nodes) and create relationships (edges) in the form of graphs that can then be retrieved by the user with queries.

A graph database stores nodes and relationships instead of tables, or documents. Data is stored without restricting it to a predefined model, allowing for a flexible way of storing and retrieving data.

The use of a graph database allows for a number of advantages. Less structurally rigid than relational databases, graph databases allow nodes to have a multitude of edges. Therefore, there is no limit on the number of relationships a node can have. Additionally, each edge can have multiple characteristics that define that edge. There is, therefore, no formal limit or standardization on how many edges each node can have, nor how many characteristics an edge can have. Graph databases can also contain many different pieces of information that would not necessarily be normally related.

In a graph database, each node is defined by pieces of information called properties. Properties could be names, dates, identification numbers, basic descriptors, or other information that would describe the node itself. Nodes are connected by edges, which can be directed or undirected.

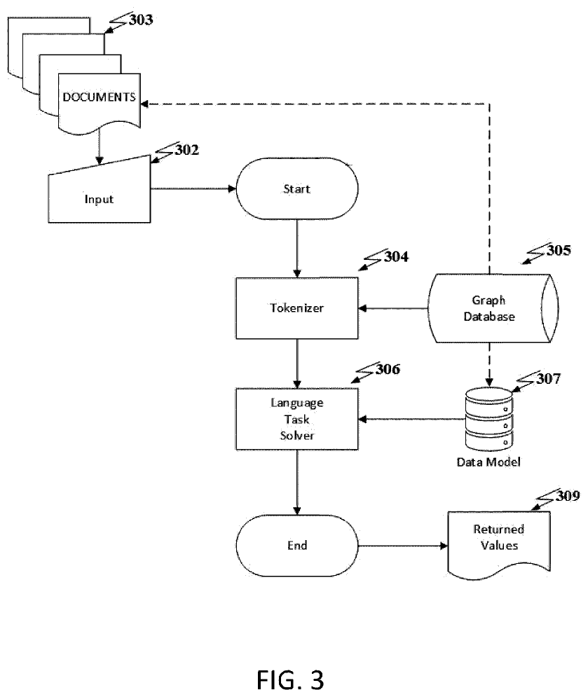

As noted above, in one aspect of the present invention, the system and method of the present invention is used to implement/execute a language related task. This can be accomplished by way of a language task solver. Schematically, one aspect of the present invention can be illustrated as shown in FIG. 3. In this aspect of the present invention, a corpus of data (comprising of documents 303) is used as input 302. The documents are tokenized using a tokenizer 304 with the assistance of a graph database 305. The graph database 305, in conjunction with a data model 307 is used with a language task solver module 306. The language task solver 306 produces the returned values 309.

Regarding the language task solver module 306, the module is chosen based on the type of language related task. In general, the type of a language task can be figured out by the number of input documents, the lengths of the input document and the number of outputs needed from the language task solver.

For clarity, language tasks or language related tasks are functions that process input containing “language”-like information to return an output that contains “language”-like information. A language task is represented as t: NM→L, to be understood as: given N documents of M lengths, produce L predictions, where there are no restrictions on the values for N, M, L.

The input to any task is represented as “NM” where “N” represents multiple number of documents, “M” represents multiple tokens in a document, representing that any task can have an input consisting of multiple documents, each being a varied-yet-uncapped length document.

The output of any task is represented as “L” where “L” represents multiple actions/choices given the input. If L is bounded by a set of objects, the language task is said to be of type “categorical”. However, if the response required is unbounded, the language task is said to be of “regression” type.

Accordingly, every language task can be represented as a function of t: NM→L, where N and M, are whole numbers. Whole numbers are in the infinite set of {0, 1, 2, 3, . . . } while L is either a whole number or a vector in complex space.

A wide variety of possible functions can be completed by language tasks. These tasks can all be considered as NM-L tasks or subsets thereof. For example, the simplest subset of these tasks is called M-1, where N and L are equal to 1. A non-exhaustive and exemplary list of the various language tasks and their associated complexity with respect to their NM-L definition follows:

M-1: These tasks involve singular document inputs (N=1) with varying token length (M>=0), however these tasks consistently map to singular outputs. An example of this is Sentiment Analysis models, which take inputs of varying length, such as a tweet or a book, and produce a simple output such as “positive” or “negative”. Another example of a language task in this category includes Relation Extraction (i.e. semantic association of entities).

M-M: These tasks involve singular document inputs (N=1) with varying token length (M>=0), however these tasks consistently map each input to the same number of outputs (L=M). An example of this is Named Entity Recognition (NER) models, which take inputs of varying length, such as a tweet or a book, and produce a classification of each token in the input to a defined category. This is useful for identifying different parts of speech such as language composition (e.g., nouns, adjectives, verbs, etc.).

M-L: These tasks involve singular document inputs (N=1) with varying token length (M>=0), with the outputted tokens not being precisely defined by the system. An example of a language task in this category is conditional generation, where a user would enable contextual information to inform output conditions.

The M-M task can be viewed as a special case of the M-L task, where the model is required to output right after processing an input token. Both methods are interchangeable, i.e., the M-L task can be emulated by an M-M task block by having an “Other” label within the M-M task block to ignore the model's predictions at certain times. In the other way, the M-M task can be emulated by the M-L task by disallowing an “Other” label, thereby forcing the model to make a prediction at all times.

Another language task is the NM-L task: The composition of these language tasks do not differ from the originally defined variables. Some examples of these tasks are summarization or conversation models. Such tasks perform better when there are no capped input restrictions on documentation or token length, and these tasks output content at varying lengths.

Within the application of summarization, the system can take many documents and produce a summary of all the documents. With the application of conversation, multiple tasks can be performed such as, among others, predicting the next speaker and what they are going to say, predicting what the AI is trained to say, prompting how the AI should behave, and predicting the sentiment of specific person(s).

It should be clear that, in one aspect of the present invention, all data transformations, data adjustments, parameter assignments, parameter adjustments, as well as all transactions or changes that affect parameters, tokens, are recorded so that they may be accessed at a later date when executing or implementing tasks. Thus, all processes, data transformations and data adjustments during any part of the tokenization of the corpus of data, incorporation of sub-trees to the graph database, or implementation/application of AI-related models to any of the various forms of data are recorded. In the description, this is referred to as recording to a “tape” but, as will be explained below, such a record can be stored in any computer accessible and computer readable storage device/format.

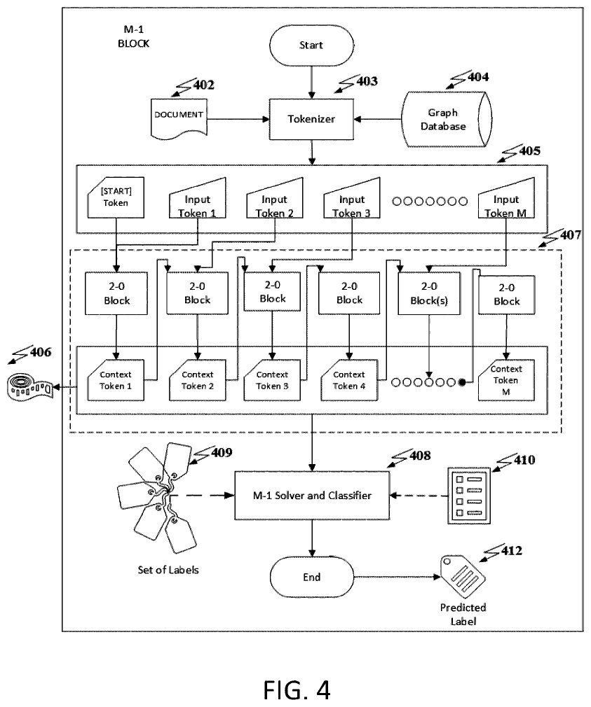

Referring to FIG. 4, illustrated is a schematic diagram of one embodiment of the present invention. The system in FIG. 4 illustrates a process for an M-1 solver. As can be seen, input document 402 is tokenized by the tokenizer 403 with assistance (if necessary) from graph database 404. This produces multiple input tokens 405 which leads to block 407 that reconstructs representations for the input data. This block 407 includes multiple 2-0 blocks that uses a composition function. This 2-0 block, detailed below, takes a context token and an input token and provides a new context token that represents the result of adding the input to the context.

It should be clear that the M-1 Solver and Classifier 408 may include a set of labels provided, which behave as actions that should be performed within the environment 409 and there could be a Dataset 410, which can be used by the model to perform or verify the action.

The output of predicted label 412 results only after the solver and classifier 408 executes its routine.

For clarity, the M-1 Solver refers to the block in the language task solver that performs the language task by accepting M tokens and providing 1 token as output. If the solution required is of a regression type, only 1 complex valued number is expected.

The Classifier in reference to FIG. 4 refers to the selection an action after the M-1 Solver makes a prediction over either the task or the actions upon the task. This implies that the M-1 Solver is treated independently to the Classifier, to accommodate for scenarios where an extrinsic task can be performed by deriving value from a model's prediction.

It should also be clear that the entire process depicted in FIG. 4, including the tokenization as well as all other sub-processes explained above, is stored in suitable storage. As noted above, this storage may be referred to in this document as a Tape 406. This Tape 406 may be recalled as needed by other processes or sub-processes as necessary. For even greater clarity, the recordation on to Tape 406 may be referred to as the recordation/storage of all operations performed on various parameters on the Tape 406 in memory (e.g. hard disk, or RAM or any other type of computer memory where these operations, parameters and intermediate values can be recalled at a later time as needed). The term “tape” is to refer to a medium for the recordation/storage of sequential operations and their intermediate outputs. The data stored in the Tape may be used by downstream tasks to perform additional operations to arrive at the results of the operations. The storage of such operations also support learning through backpropagation from feedback given by an external environment.

It should also be clear that the term tape also may refer to the storage medium on which operations performed on various parameters are recorded. These operations may be recorded as a computation graph, which describes how various parameters interact with each other.

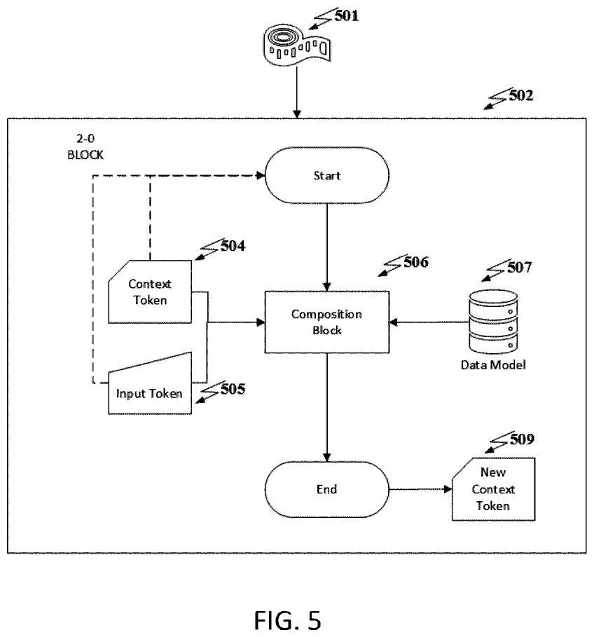

As noted above, FIG. 4 includes multiple 2-0 Blocks. FIG. 5 details the components and/or operations involved in a 2-0 block. As with the system/method in FIG. 4, all operations involved in the 2-0 block as also stored or recorded on to a Tape where such operations and the data they generate can be retrieved as necessary.

Referring to FIG. 5, it should be clear that the 2-0 Block 502 in FIG. 5 is a basic building block of the task solver shown in FIG. 4. The 2-0 block uses a composition block to combine two input tokens to provide an output token that represents the two input tokens. The goal of the 2-0 Block is to reconstruct representations of the tokenized input while taking advantage of the opportunity to add external information about the inputs into future representations that can be used by the AI agent. A data model 507 may be used in this process.

The composition block 506 in FIG. 5 uses symbolic composition. Symbolic composition describes a function which has, as inputs, two representations of information (either partially or explicitly representing the input's properties), and returns a single output. The output is represented in the same representation space as the inputs, however the output summarizes and consolidates the information contained within the inputs, while augmenting the inputs with external information.

As can be seen from FIG. 5, the result is a new context token 509. This new context token 509 represents the sum of the two inputs 504, 505 to the composition block 506, where one of the inputs represents the context 504 (a summary of all previous inputs along with extra information pieces about the inputs, or a special [START] context token if no token has been processed yet) and the other input is an input token 505. All operations by the 2-0 block is, of course, recorded on tape 501.

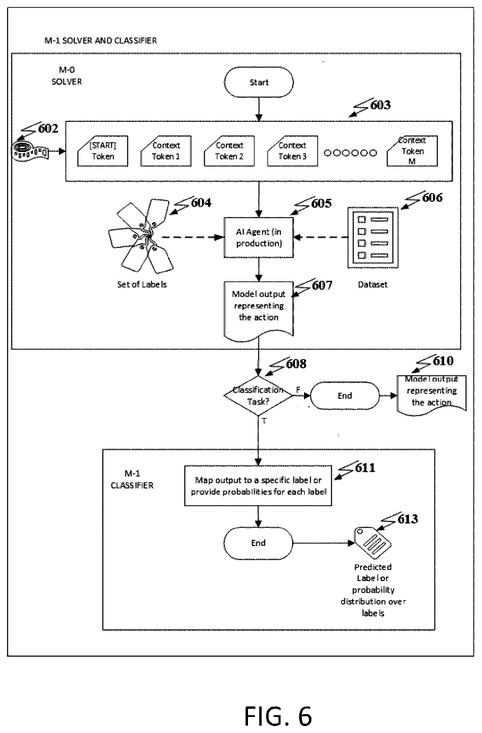

Referring to FIG. 6, illustrated is a block diagram detailing components and methods steps for an M-1 solver and classifier. As can be seen, the tokenized input, including context tokens (reference 603) are sent to an AI-related model 605.

In this embodiment, the tokenization pre-processing produces the tokenized output of a tokenized document. As explained above, this tokenization process is recorded on a suitable tape.

The AI related model 605 processes the tokenized output 603 and may be provided a Set of Labels 604 and may also be assisted by a Dataset 606. For clarity, the AI-related model has been previously trained and may implement actions that need to be executed in a certain environment based on the input. As an example, in unsupervised learning scenarios, no labels or feedback about selecting actions is provided to the AI related model/agent. The process of executing that action could be assisted or verified by the Dataset. As an example, AI algorithms such as k-means and k-nearest-neighbors require the dataset to be present during inference type, while learning based algorithms try to compress the datasets within rules and/or parameters.

Alternatively to the above scenario, previously trained AI related model processes the tokenized output independently and may or may not rely on the dataset to perform the processing of the tokenized output.

After the AI related model has been applied to the tokenized output, model output 607 is produced. This output 607 may be in the form of a single value, a vector in complex space, or readable strings.

In one embodiment, a check is performed to determine if the language task is that of regression or classification. This check is detailed in decision 608 that decides whether the language task is a classification task. If the task is not a classification task (and is therefore a regression task), then the model output is provided as the system output 610. If the language task is a classification task, then the model output is provided to an M-1 Classifier block. This classifier block maps the model output to a specific label or provides probabilities for each possible label (reference 611). The system output 613 is therefore the predicted label or the probability distribution over the possible labels.

For FIG. 6, the M-1 Solver refers to the block in the language task solver that performs the language task by accepting M tokens and providing 1 token as output. If the solution required is of a regression type, only 1 complex valued number is expected. Similarly, the term Classifier refers to the selection of an action after the M-1 Solver makes a prediction over either the task or the actions upon the task. This implies that the M-1 Solver is treated independently to the Classifier, to accommodate for scenarios where an extrinsic task can be performed by deriving value from a model's prediction. As with the other operations, all operations and intermediate data generated is stored in a tape 602.

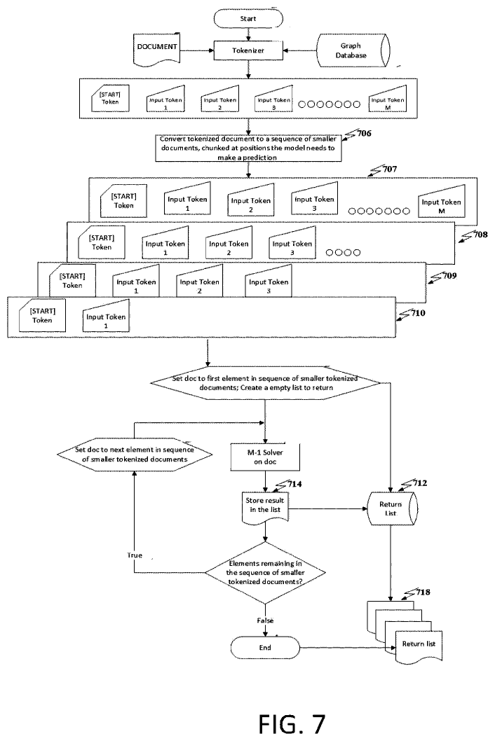

Referring to FIG. 7, illustrated is a schematic diagram illustrated the steps executed by the various components of the system when the AI related model is used to make predictions from a corpus of data. As can be seen and as explained above, the input corpus of data (which may be a single document or a collection of documents for a language related task) is tokenized. This generates input tokens and, in 706, these input tokens are chunked or organized into smaller groups of tokens 707, 708, 709, 710 for processing by the AI related model. The various groups of tokens is then processed by an execution block that may include a single execution unit (that applies the AI related model to each group of token in a sequential manner) or may include multiple execution units. For clarity, each of the multiple execution units applies the AI related model to a group of tokens simultaneously in a parallel manner. For the sequential implementation, a single return list (with the predicted results) is generated. In the parallel processing implementation, each execution unit may produce a return list and these various return lists are collated and/or combined into a single unitary result list that operates as the system's single output.

For clarity, for the sequential implementation, processing of each group continues until no more groups remain to be processed by the single execution unit. For the parallel implementation, each of the parallel execution units operates on a group of tokens and each of the parallel execution units may operate on multiple groups of tokens in sequence. As with the sequential implementation, for the parallel implementation, processing continues until no more groups of tokens remain to be processed.

It should be clear that the M-1 Solver on doc 713 (which implements the AI related model) provides a prediction based on the tokenized data received and this prediction is stored 714 in the Return List 712. The accumulated Return Lists are provided as the output 718 of the process.

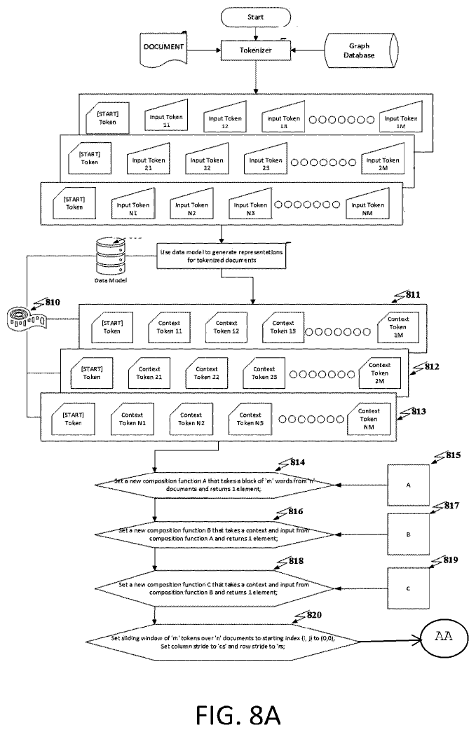

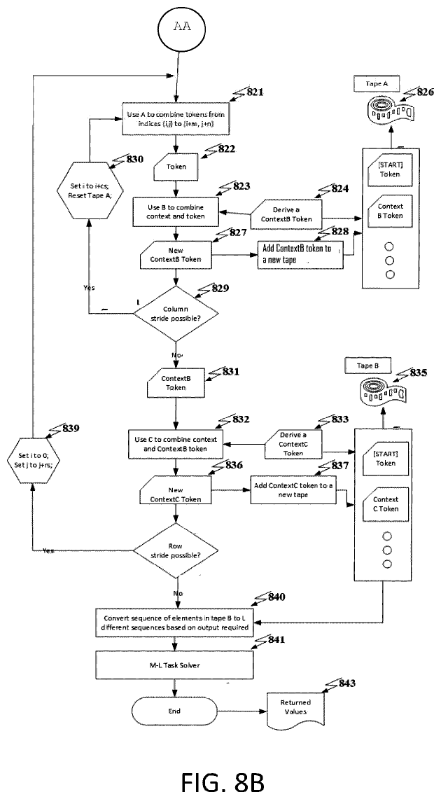

Referring to FIGS. 8A and 8B, these figures detail the steps for an NM-L block.

As with FIG. 6 and FIG. 7, the initial steps in FIG. 8A involves the reception of a corpus of data and the tokenization of that input corpus. The tokenized inputs are then divided into groups 811, 812, 813 of input tokens and context tokens. Each of the groups of tokens can then be processed separately. As with the other language tasks detailed above, the process for the generation of these tokens is stored on tape 810.

It should be clear that FIG. 8A and FIG. 8B detail a single process/system. The bottom block in FIG. 8A (see connector AA) continues at the top of FIG. 8B (see corresponding connector AA). This single process/system provides a summary of the input documents that have been tokenized.

From FIG. 8A, after the tokenized input has been grouped, then block 814 is that of setting a new composition function A that takes a block of ‘m’ words from ‘n’ documents and returns 1 element. This unique version of the composition function A is denoted 815 in FIG. 8A. This composition function may be borrowed from the data model or, alternatively, this composition function may not be related to the data model. The output of this composition function A can be viewed as a summary for the words contained within a sliding window over the documents that need to be summarized.

Once composition function A has been created, then block 816 is that of setting a new composition function B that takes a context and input from composition function A and returns 1 element. The composition function B (referred to by reference 817 in FIG. 8A) represents a composition function in a different memory space from the composition function within the data model and composition function A. Similar to composition function A, composition function B may be borrowed from the data model or, alternatively, this composition function B may not be related to the data model.

The output of composition function B can be viewed as a context generator across the document axis, i.e., as the sliding window reads specific blocks of tokens across documents, this composition function B combines the information pieces generated by composition function A. This can be viewed as a context generator for the next composition function.

After composition function B has been addressed, the next block 818 is that of setting a new composition function C that takes a context and input from composition function B and returns 1 element. Composition function C (denoted 819 in FIG. 8A) is a new composition function that is separate from the other composition functions A and B. Composition function C takes a context and input from composition function B and returns 1 element. The output of this composition function C can be viewed as a summary generator, i.e., as context is generated by composition function B, composition function C adds the collected information into the summary. The summary generated by the composition function C can then be used by a downstream M-L block to perform the required language task.

Once composition function C has been dealt with, the next block 820 is that of setting a sliding window of ‘m’ tokens over ‘n’ documents to starting index (i, j) to (0,0). As part of this step, column stride is set to ‘cs’ and row stride is set to ‘rs. As can be seen, the next step is detailed by the connector AA in FIG. 8B.

In FIG. 8B, block 821 is that of using A to combine tokens from indices (i, j) to (i+m, j+n) to result in token 822. Then, after token 822 is generated, block 823 is that of using B to combine context and token. A ContextB token is derived (block 824) while combining the context and the token in block 823.

Block 823 results in a new ContextB token (block 827). This ContextB token is then added to a new tape (block 828). For clarity, all of the steps are stored in a tape and, once ContextB token has been derived, a new tape (TapeA 826) is started for all the processes and tokens relating to B. The new ContextB token (block 827) is added to this new tape.

After the new ContextB token has been generated, then a decision 829 as to whether a column stride is possible is made. For clarity, column stride refers to striding across documents, i.e., sliding over a specific block of tokens across the documents. If a column stride is possible, then block 830 is that of setting i to i+cs and a reset of TapeA is performed and logic loops to block 821. Alternatively, if a column stride is not possible then retain ContextB Token is retained (block 831).

In the event ContextB token is retained, the next block 832 is that of using C to combine context and the ContextB token that was retained. Block 833 is then that of deriving a ContextC Token. Thus, block 832, that of using C to combine context and ContextB token to derive a ContextC Token leads to a new ContextC token 836. This new ContextC token is added to a new tape 837. As with the process for the creation and generation of TapeA, a new TapeB 835 is started and this TapeB includes ContextC tokens.

After the new ContextC token has been generated (block 836), then a decision 838 as to whether a row stride is possible is made. For clarity, row stride refers to striding across the length of documents, which can be viewed as consuming multiple document chunks in parallel and providing an update to the summary after each chunk. If a row stride is possible, then block 839 is that of setting i to 0 and setting j to j+rs and looping the logic back to block 821.

However, if a row stride is not possible, then block 840 is that of converting the sequence of elements in Tape B to L different sequences based on output required. The next block is then that of processing by the M-L Task solver 841. For clarity, this means that the output of the conversion of the sequence of elements recorded in Tape B to L different sequences based on output required is processed by the M-L Task Solver. After processing by the M-L Task Solver, the Returned Values 843 are provided.

In terms of implementation, the various systems and methods of the present invention may be implemented using any number of online or cloud computing platforms, with each execution unit being one or more clusters of processing units that are operating in parallel. Similarly, for sequential implementations, the execution unit can be one or more processing units operating in sequence. Storage of the various inputs, outputs, results, and tapes detailed above, including the resulting larger tree, perhaps implemented as a database of graphs, may be implemented by way of a cloud computing storage platform.

The present invention relates to systems and methods for applying an AI related pre-trained model for a language task to a corpus of data. The corpus of data, a collection of text related data such as documents, is preprocessed to produce tokenized data. The preprocessing step, a tokenization process, takes a portion of data from the corpus of data and recursively decomposes that portion of data until the portion has been decomposed into the smallest units of data for that data type. The tokenization process then repeats with different portions of data from the corpus of data until no more data needs to be tokenized.

The resulting tokenized data can then be grouped into groups of tokenized data and processed by way of an execution block. The execution block can include a single execution unit that takes each group of tokenized data and processes the groups in sequence. The execution block can take the form of multiple execution units operating simultaneously in parallel with each execution unit processing a group of tokenized data. The execution unit applies the AI related model to the group of tokenized data being processed.

The execution block is an implementation of a language task solver that implements the AI related model and that returns the returned values for the process. The language task solver solves or completes language tasks such as: sentiment analysis; relation extraction; named entity recognition; conditional generation; summarization; predicting a next speaker; predicting sentiment; predicting next statements; and symbolic composition.

Part of the processing includes taking a context token and an input token and producing a new context token that represents the result of adding the input token to the context token. This process is cascaded through sequentially with the various tokenized data serving as the input token while the context is derived/created from a previous step of the cascade. The resulting context tokens and input tokens are then used with an M-1 solver block and may include a labeling sub-task after the initial language task is complete. After the M-1 solver block, a classification task may be implemented instead of or in conjunction with the labeling sub-task.

For a prediction language task, each group of tokenized data is processed in turn with the M-1 solver being applied to the group of tokenized data. The result of the processing is stored in a return list and the next group of tokenized data is processed. The process continues until all groups of tokenized data has been processed. The resulting return lists are the output of the language task.

For a summarization language task, the processing involves multiple composition functions that are cascaded. The output of one composition function is used as the input to the next composition function. These composition functions are later reused to combine context and combined tokens or to combine a context and a previously generated context token to result in new context tokens.

The resulting sequences are then used in an M-L task solver to result in final returned values.

It should be clear that all the processes and transformations and adjustments that affect parameters and data are recorded so that they may be retrieved for later use.

It should be clear that the various aspects of the present invention may be implemented as software modules in an overall software system. As such, the present invention may thus take the form of computer executable instructions that, when executed, implements various software modules with predefined functions.

Additionally, it should be clear that, unless otherwise specified, any references herein to ‘image’ or to ‘images’ refer to a digital image or to digital images, comprising pixels or picture cells. Likewise, any references to an ‘audio file’ or to ‘audio files’ refer to digital audio files, unless otherwise specified. ‘Video’, ‘video files’, ‘data objects’, ‘data files’ and all other such terms should be taken to mean digital files and/or data objects, unless otherwise specified.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g., “C” or “Go”) or an object-oriented language (e.g., “C++”, “java”, “PHP”, “PYTHON” or “C #”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A method for processing a corpus of data using at least one AI-based model, the method comprising:
a) receiving said corpus of data;
b) applying a pre-processing method to said corpus of data to generate and extract information regarding said data in said corpus of data and to generate preprocessed data, said preprocessed data being stored in a graph database;
c) applying said at least one AI-based model to said preprocessed data using an execution block.

2. The method according to claim 1, wherein said pre-processing method includes a decomposition step, said decomposition step comprising recursively decomposing a collection of data from said corpus of data into smaller and smaller sub-groups of data, wherein for each sub-group of data that said collection of data is decomposed into, said sub-group is tokenized and a resulting token is stored in a node in a tree along with multiple parameters relating to said resulting token.

3. The method according to claim 2, wherein said preprocessing method includes repeating said decomposition step until said collection of data has been decomposed into smallest units of data for a data type for said collection of data and until said smallest units of data have been tokenized and resulting tokens have been stored in said tree,
and wherein said decomposition step includes grafting said tree resulting from said method to a larger tree.

4. The method according to claim 3, wherein said preprocessing method includes repeating said decomposition step until all of said corpus of data has been tokenized and resulting tokens have been grafted to said larger tree.

5. The method according to claim 4, wherein said larger tree is converted into said graph database.

6. The method according to claim 4, wherein said graph database is a preexisting graph database and said larger tree is converted and incorporated into said preexisting graph database.

7. The method according to claim 1, wherein said preprocessed data is tokenized data and step c includes retrieving multiple sets of tokenized data from said graph database, each of said multiple sets of tokenized data being subsets of said corpus of data.

8. The method according to claim 7, wherein said execution block comprises an execution unit for applying an AI based model to a set of tokenized data and said multiple sets of tokenized data are sent to said execution unit in a sequential manner.

9. The method according to claim 7, wherein said execution block comprises a plurality of execution units operating in parallel, each of said plurality of execution units being for applying an AI based model to a set of tokenized data and said multiple sets of tokenized data are sent to said plurality of execution units in parallel such that said AI based model is applied to said sets of tokenized data simultaneously in parallel.

10. The method according to claim 1, wherein said AI based model performs a language-based task.

11. The method according to claim 1, wherein step c) includes applying a step of labelling one or more results from an application of said AI based model to said preprocessed data.

12. The method according to claim 10, wherein said language-based task is any one of:
sentiment analysis;
relation extraction;
named entity recognition;
conditional generation;
summarization;
predicting a next speaker;
predicting sentiment;
predicting next statements;
symbolic composition.

13. The method according to claim 1, further comprising a step of saving all processes and data transformations and data adjustments in computer readable and computer accessible media.

14. A system for implementing a language task using an AI related model, the system comprising:
a tokenizer for receiving and tokenizing a corpus of data to result in tokenized input data;
a language task solver module receiving said tokenized input data and applying said AI related model to said tokenized input data;
wherein
said tokenizer tokenizes at least a portion of said corpus of data by recursively decomposing said portion into smaller and smaller sub-groups of data, wherein for each sub-group of data that said portion is decomposed into, said sub-group is tokenized and a resulting token is stored in a node in a tree along with multiple parameters relating to said resulting token;
said language task solver is implemented in an execution block.

15. The system according to claim 14, wherein said execution block comprises an execution unit implementing said AI related model on sequentially processed groups of tokenized input data.

16. The system according to claim 14, wherein said execution block comprises a plurality of execution units, each of said plurality of execution units implementing an instance of said AI related model on a group of tokenized input data, multiple instances of said AI related model being applied to multiple groups of tokenized input data simultaneously in parallel.

17. The system according to claim 14, wherein all processes and transformations and adjustments executed by said system that affect parameters and data are recorded.
